(19) United States
(12) Patent Application Publication
(10) Pub. No.: US 2006/0024457 A1
(43) Pub. Date: Feb. 2, 2006

(54) Blowing machine for loose-fill insulation material

(76) Inventors: Robert J. O'Leary, Newark, OH (US); Willard Price, Granville, OH (US)

Correspondence Address: OWENS CORNING, 2790 COLUMBUS ROAD, GRANVILLE, OH, 43023, US

(21) Appl. No.: 11/141,653

(22) Filed: Aug. 1, 2005

Related U.S. Application Data
(63) Continuation-in-part of application No. 10/899,909, filed on Jul. 27, 2004.

(51) Int. Cl. B31B 45/00

(52) U.S. Cl. 428/34.1

(57) ABSTRACT

A machine for distributing blowing wool from a bag of compressed blowing wool includes a collapsible chute configured to receive the blowing wool, a separator mounted at an outlet end of the chute and configured to pick apart the blowing wool and a blower for distributing the picked apart blowing wool into an airstream.

### RELATED APPLICATION

This application is a Continuation-In-Part application of U.S. patent application Ser. No. 10/899,909 filed Jul. 27, 2004, now pending, and entitled BLOWING MACHINE FOR LOOSE-FILL INSULATION MATERIAL, all of which is incorporated in the present application in its entirety.

### TECHNICAL FIELD

This invention relates to loose-fill insulation for insulating buildings. More particularly this invention relates to distributing loose-fill insulation packaged in a bag.

### BACKGROUND OF THE INVENTION

In the insulation of buildings, a frequently used insulation product is loose-fill insulation. In contrast to the unitary or monolithic structure in insulation batts or blankets, loose-fill insulation is a multiplicity of discrete, individual tufts, cubes, flakes or nodules. Loose-fill insulation is usually applied to buildings by blowing the insulation into an insulation cavity, such as a wall cavity or an attic of a building. Typically loose-fill insulation is made of glass fibers although other mineral fibers, organic fibers, and cellulose fibers can be used.

Loose-fill insulation, commonly referred to as blowing wool, is typically compressed and packaged in bags for transport from an insulation manufacturing site to a building that is to be insulated. Typically the bags are made of polypropylene or other suitable material. During the packaging of the blowing wool, it is placed under compression for storage and transportation efficiencies. Typically, the blowing wool is packages with a compression ratio of at least about 5:1. The distribution of blowing wool into an insulation cavity typically uses a blowing wool distribution machine that feeds the blowing wool pneumatically through a distribution hose. Blowing wool distribution machines typically have a large chute or hopper for containing and feeding the blowing wool after the bag is opened and the blowing wool is allowed to expand.

It would be advantageous if blowing wool machines could be improved to make them easier to use and transport.

### SUMMARY OF THE INVENTION

The above objects as well as other objects not specifically enumerated are achieved by a machine for distributing blowing wool from a bag of compressed blowing wool. The machine includes a collapsible chute configured to receive the blowing wool, a separator mounted at an outlet end of the chute and configured to pick apart the blowing wool and a blower for distributing the picked apart blowing wool into an airstream.

According to this invention there is also provided a machine comprising a collapsible chute configured to receive the blowing wool, a separator mounted at an outlet end of the chute and configured to pick apart the blowing wool, a blower for distributing the picked apart blowing wool into an air stream and a locking mechanism to fix the collapsible chute in an extended position.

According to this invention there is also provided a machine comprising a readily removable and replaceable chute configured to receive the blowing wool, a separator mounted at an outlet end of the chute and configured to pick apart the blowing wool, and a blower for distributing the picked apart blowing wool into an air stream.

### BRIEF DESCRIPTION OF THE DRAWINGS

FIG. 1 is a side view in elevation of an insulation blowing wool machine.

FIG. 2 is a front view in elevation of the insulation blowing wool machine of FIG. 1.

FIG. 3 is a partially cutaway elevational view of the machine of FIG. 1.

FIG. 4 is an elevational view of the shredder of the blowing wool machine of FIG. 1.

FIG. 5 is a side view of the spacer of FIG. 4.

FIG. 6 is a side view of the spacer of FIG. 5, taken along line 6-6.

FIG. 7 is a side view of the spacer of FIG. 5, taken along line 7-7.

FIG. 8 is an elevational view of the ripper of the blowing wool machine of FIG. 3.

FIG. 9 is an elevational view of the ripper roller of FIG. 8.

FIG. 10 is a side view of the ripper of FIG. 8.

FIG. 11 is a perspective view of a bag of blowing wool having a tear-away end.

FIG. 12 is a perspective view of a different bag of blowing wool, packaged in a sleeve.

FIG. 13 is a side view in elevation of an insulation blowing wool machine comprising a collapsible telescoping chute in an extended and locked position.

FIG. 14 is a side view in elevation of an insulation blowing wool machine having a collapsible telescoping chute in the collapsed position.

FIG. 15 is a side view in elevation of a bellows style collapsible chute in the extended and locked position.

FIG. 16 is a side view in elevation of a bellows style collapsible chute in the collapsed position.

FIG. 17 is a side view in elevation of a spiral style collapsible chute in the extended and locked position.

FIG. 18 is a side view in elevation of a spiral style collapsible chute in the collapsed position.

FIG. 19 is a side view in elevation of a foldable style collapsible chute in the extended position.

FIG. 20 is a side view in elevation of a foldable style collapsible chute in the collapsed position.

FIG. 21 is a side view in elevation of a disassembled and removed chute.

FIG. 22 is a side view in elevation of a removed and replaceable one piece chute.

### DETAILED DESCRIPTION OF THE INVENTION

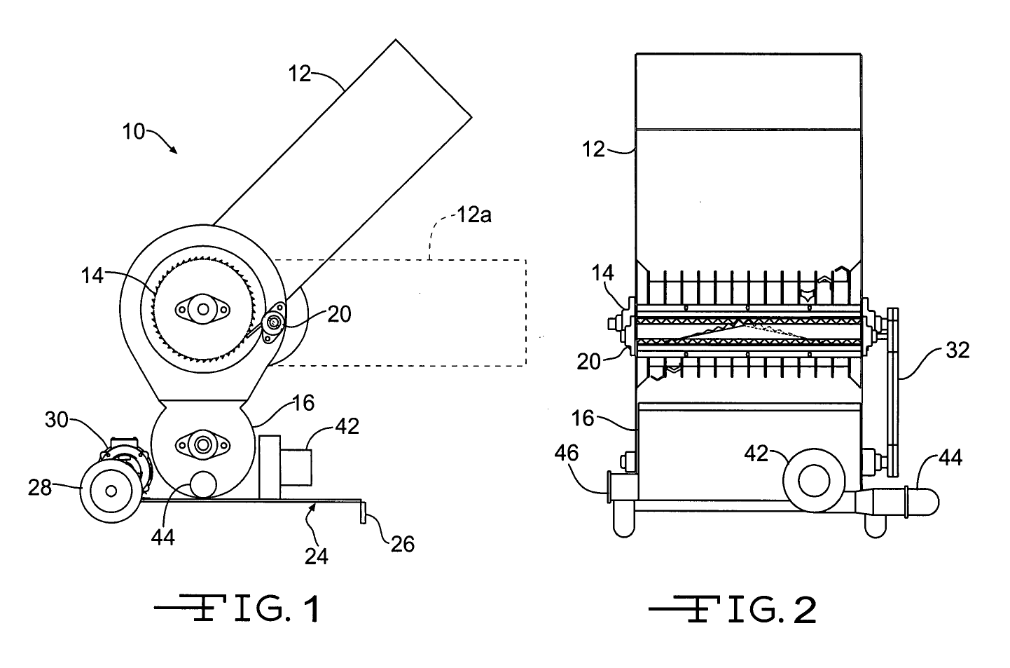

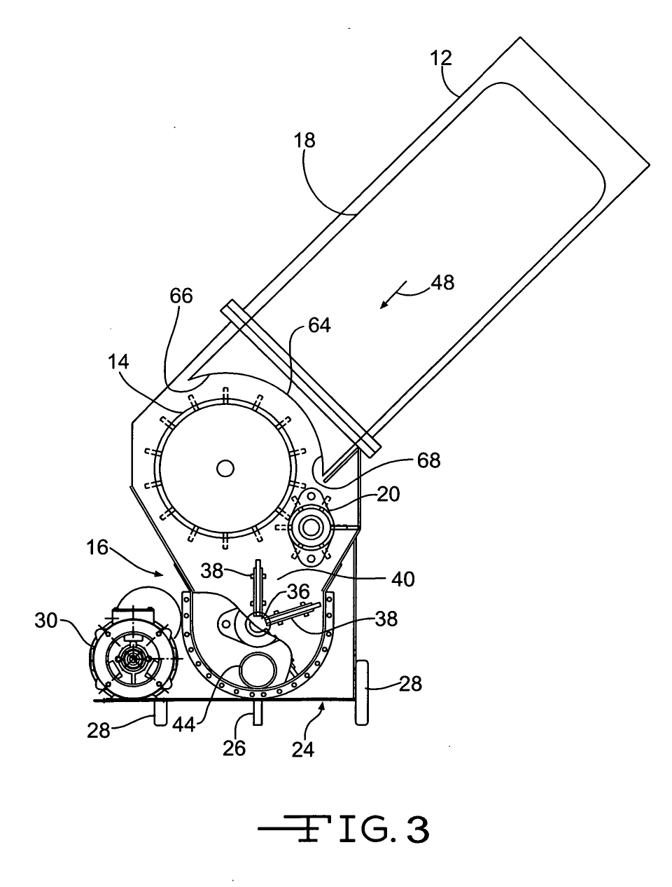

As shown in FIGS. 1-3, the blowing wool machine is indicated at 10. The machine 10 includes a chute 12 configured to receive a bag of insulation material, and a shredder 14 for shredding the bag of insulation and picking apart the blowing wool. A rotary valve 16 is also included in the blowing wool machine 10 for distributing the blowing wool. As shown in FIG. 3, a bag of compressed blowing wool 18 is placed in the chute 12 to introduce the blowing wool to the shredder 14. In general, the shredder 14 shreds the bag 18 of blowing wool and the blowing wool is distributed by means of the rotary valve 16. Also included in the blowing wool machine 10 is a ripper 20 for ripping apart a portion of the material of the bag 18 as the shredder 14 engages the bag 18 at the outlet end of the chute 12. Optionally, the machine is mounted on a frame 24, which includes a handle 26 and wheels 28. This makes the machine relatively easy to move from one location to another. Also, optionally the chute can be mounted for a rotation to a retracted position as shown at 12a for ease of storage and transportation. The shredder 14, ripper 20, and rotary valve 16 are all mounted for rotation. They can be rotatably driven by suitable means, such as by motor 30 and belts and pulleys 32. Alternatively, each of the shredder 14, ripper 20, and rotary valve 16 can be provided with its own motor.

The shredder 14 shreds the bag 18 and picks apart the blowing wool, and the shredded bag pieces and the blowing wool drop from the shredder 14 into the rotary valve 16. As shown in FIG. 3 the rotary valve includes a central hub 36 and a plurality of vanes 38 arranged radially. The vanes form compartments 40 which collect the bag pieces and blowing wool. When the rotary valve 16 rotates to the lowest position the compartment 40, the bag pieces and blowing wool will be entrained by the flowing stream of air from the blower 42, which is shown in FIG. 2. The blower 42 draws air from the inlet 44 and through the lowermost compartment 40 of the rotary valve 16, and then through the outlet 46 to distribute the blowing wool and shredded bag pieces. Attached to the outlet 46 is a distribution hose, not shown, for directing the airstream of blowing wool and shredded bag parts toward the insulation cavity.

The blowing wool in bag 18 can be any loose-fill insulation, such as a multiplicity of discrete, individual tuffs, cubes, flakes, or nodules. The blowing wool can be made of glass fibers or other mineral fibers, and can also be organic fibers or cellulose fibers. The blowing wool in the bag 18 is compressed to a compression ratio of at least 5:1, which means that the unconstrained blowing wool after the bag is removed has a volume of 5 times that of the blowing wool in the bag. Typically, the compression ratio is about 20:1 or higher. The bag itself is typically made of a polymeric material, such as polyethylene, although any type of material suitable for maintaining the blowing wool in the desired compression can be used. Preferably, the bag will provide a waterproof barrier against water, dirt and other deleterious effects. By using a polymeric material for the bag, the blowing wool will be protected from the elements during transportation and storage of the bag. The preferred bag material is sufficiently robust to handle the physical abuse to which these bags are frequently subjected.

Typical bags of compressed blowing wool have rounded generally rectangular cross-sectional shapes. For example, the bag might have a height of about 8 inches, a width of about 19 inches and a length of about 38 inches. Such a bag might have a weight of about 35 pounds. Optimally, the chute 12 has a cross sectional shape which approximates the cross section of the bag 18. For example, for the bag specified above, the chute 12 might have a cross-section of about 9 inches by 20 inches. This allows the bag to be easily received and fed through the chute 12 in the machine direction 48 to be engaged by the shredder 14. By providing the chute with a cross section that approximates the cross section of the bag 18, the bag 18 will be contained and prevented from expanding prior to the point at which the bag is engaged by the shredder 14. The bag 18 can be moved through the chute 14 by the force of gravity if the chute is in a raised or upright position, as shown in FIG. 1. Alternatively, a ram or pusher, not shown, can be used to move the bag 18 along the chute 12. Where a ram is used, the chute 14 does not have to be in a vertical position, as shown in FIG. 1, but rather can be in any suitable orientation.

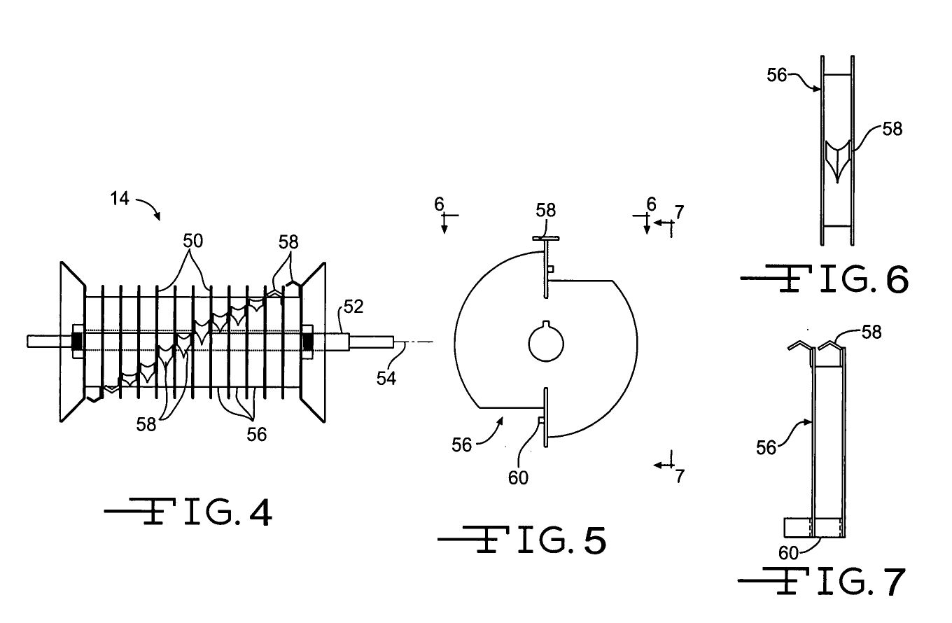

As shown in FIGS. 4-7, the shredder 14 includes a plurality spaced apart blades 50, mounted for rotation on a shredder shaft 52, which is aligned along the shredder axis 54. The spaced apart blades 50 are generally parallel to the machine direction 48. Typically the shredder blades 50 are mounted on centers of 1.25 inches although other spacings can be used. The blades 50 are spaced apart by spacers 56. The spacers 56 are generally disc shaped as shown in FIG. 5. Preferably the blades 50 and the spacers 56 are keyed to fix them to the shredder shaft 52. When viewing FIG. 4, it can be seen that the blades 50 extend outwardly from the shredder 14. When the bag of compressed blowing wool 18 engages the shredder 14, the rotating blades 50 define cuts or slits in the blowing wool.

Mounted on the spacer 56 is a mechanism which picks apart the blowing wool between the cuts made by the blades 50. The mechanism can be any suitable member for picking apart or loosening the highly compressed blowing wool between the cuts formed by the blades 50. In a preferred embodiment of the invention the mechanism is a plow shaped member, or plow 58 having a central ridge and outwardly extending flanges. Preferably the plow 58 is mounted on the spacer 56 in a cantilevered manner, although other mounting configurations can be used. The leading edge of the plow 58, being pointed, enables the plow 58 to dig into the blowing wool between the cuts made by the spacer 56. It can be seen from FIG. 4 that each spacer 56 is provided with one plow 58, and that the plows are staggered circumferentially about the shredder shaft 52 so that only one of the plows 58 engages the blowing wool at a time. Although the spacer 56 is shown with one plow 58, the spacer 56 can function with more than one plow 58. Also the plows of adjacent spacers need not be staggered circumferentially. With the plow 58 rotating clockwise, as shown in FIG. 3, the leading edge of the plow is oriented tangentially to the outer perimeter of the shredder, in the direction of rotation.

Also positioned on each of the spacers 56 is a mechanism, such as scoop 60, for removing the blowing wool insulation material ripped apart or loosened by the plow 58. The scoop 60 is generally diametrically opposed from the plow 58 on the spacer 56, as shown in FIG. 5. The scoop 60 can be any member, including a flange, a fork, or a web, suitable for removing the blowing wool insulation material ripped apart or loosened by the plow 58. Although not shown, more than one scoop 60 could be attached on each spacer 56.

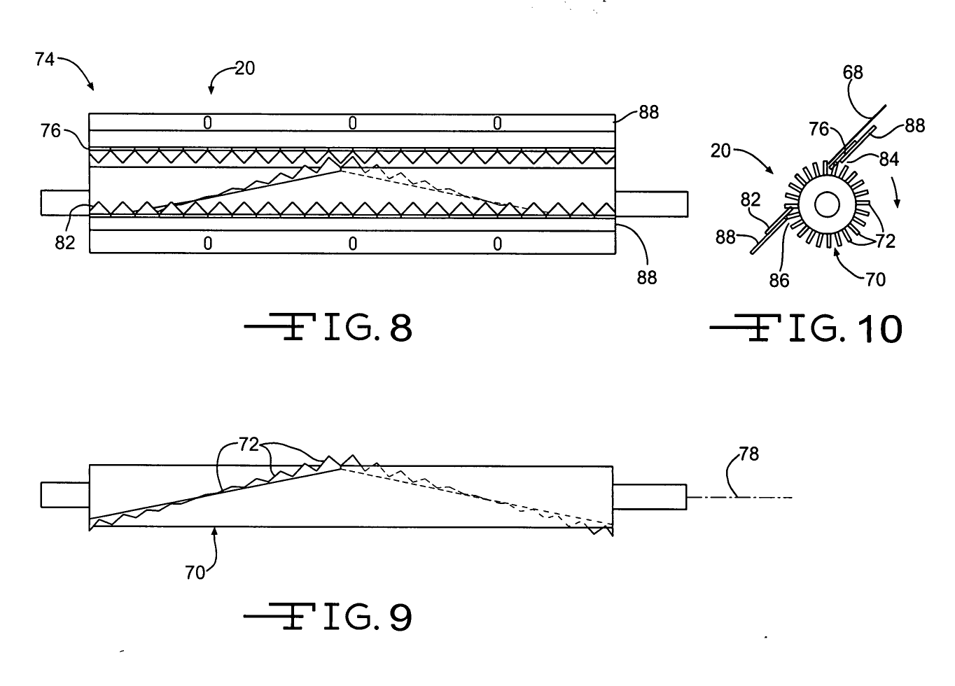

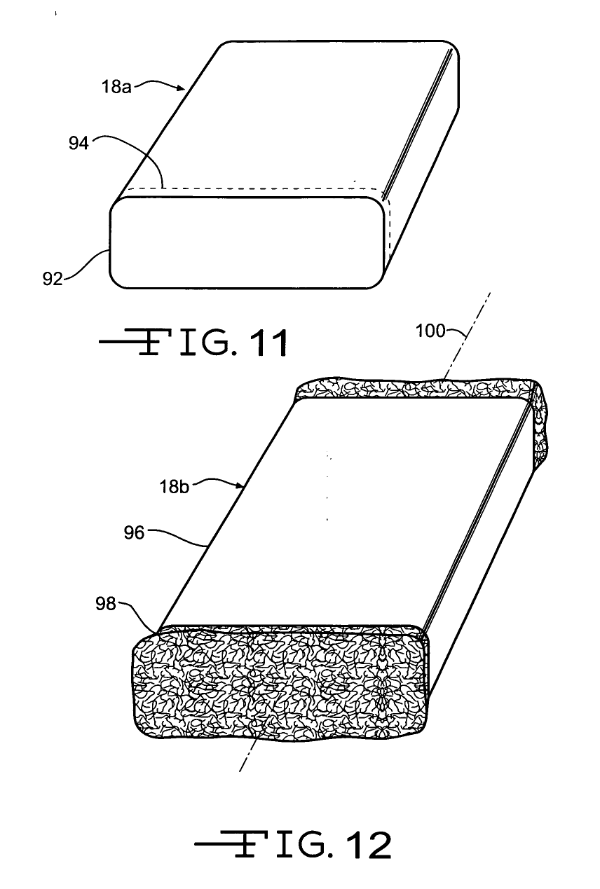

As the bag 18 is being fed downwardly to engage the shredder 14, the shredder consumes the lower most surface 64 of bag and the blowing wool contained in the bag 18, as shown in FIG. 3. The lower most surface 64 is formed in a curved shape because of the action of the curved shredder 14. The plows 58 on the spacers 56 easily shred the bag 18 and pick apart the highly compressed blowing wool, particularly at the leading edge 66 of the bag and along most of the lower most surface 64. The leading edge 66 is the portion of the lowermost surface 64 that is first encountered by the rotating blades 50. However because of the orientation of the plow 58, the trailing edge 68 of the bag 18 is not readily shredded. In order to shred all parts of the bag 18, the ripper 20, distinct from the shredder 14, is provided to assure that the trailing edge portion 68 of the bag 18 is ripped apart. As shown in FIGS. 8-10, the ripper 20 is comprised of rotatably mounted roller 70 having a plurality of teeth 72 positioned along the length of the roller 70.

The ripper 20 also includes an anvil framework 74 intersecting the roller 70. The framework 74 has a cutting edge 76 which has a shape complimentary to the cutting teeth 72 on the roller 70 so that portions of the bag enmeshed between the cutting teeth 72 of the roller 70 and the cutting edge 76 of the framework 74 will be ripped apart. Preferably the cutting edge 76 includes substantially triangular gaps, and the teeth 72 are substantially triangular in shape for a close tolerance, in a manner similar to that of pinking shears. It is to be understood that other shapes for the teeth 72 and the cutting edge 76 can be used. Although the teeth 72 can be aligned along a line parallel to the roller axis 78, it is preferred that the teeth 72 be spaced apart circumferentially about the roller to avoid an uneven impact during the ripping operation. In such a case, each of the teeth 72 will have a different angular or radial orientation from all the other teeth. This is shown in FIG. 10. Preferably, the teeth 72 are arranged on the roller 70 so that the teeth 72 are mounted along a single spiral line along the length of the roller 72. The teeth 72 can be fastened to the roller 70 in any suitable manner, such as by bolting the teeth 72 on the roller 70 with brackets, not shown. In a preferred embodiment of the invention, the teeth 72 are made of steel, and each tooth has a length along the roller axis 78 of approximately 1.25 inches, and has a thickness of approximately 0.125 inches. As shown in FIGS. 8 and 10, the ripper 20 can include a second cutting edge 82. The purpose of the second cutting edge 82 is to assure that ripped apart bag portions are removed from the roller 70 don't wrap around the roller. Other mechanisms could be used to clean the teeth 72.

Preferably, the roller 70 intersects the cutting edge 76 at a first location 84 and intersects the section cutting edge 82 at a second location 86, spaced apart circumferentially from the first location 84, as shown in FIG. 10. In a preferred embodiment of the invention, the cutting edge 76 and the second cutting edge 82 are mounted to the machine 10 by means of brackets 88. Any other means of attachment can be used.

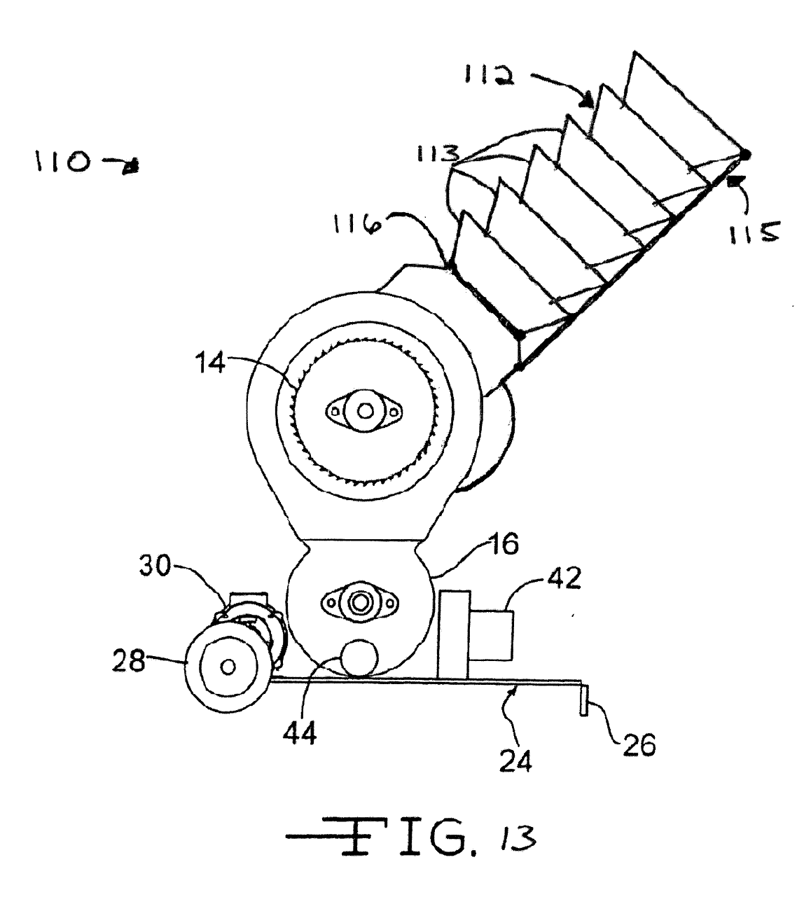

In order to facilitate the shredding of the bag as it moves in the machine direction 48 in the chute 12, it is desirable to remove the end 92 of the bag 18a. For this purpose, in one embodiment of the invention, the bag, indicated in FIG. 11 at 18a, is provided with a tear-away mechanism 94. The tear-away mechanism can be a line of serrations or weakened bag material, or can be a ripcord, not shown. Other tear-away mechanisms can also be used. In practice, the operator of the blowing wool distributing wool machine 10 tears away the tear-away portion or end 92 of the bag 18a and places the bag into the chute 12. The tear-away end of the bag 92 can be provided at either end or both ends of the bag 18a.

As shown in FIG. 12, in another embodiment of the invention, the bag of blowing wool, indicated at 18b, can be in form of a sleeve 96 which contains or encapsulates the body of blowing wool material 98. Preferably both of the ends are open, thereby eliminating the need for end bag material to be shredded by the shredder 14 and the ripper 20. Since the blowing wool 98 in typical bags of blowing wool is typically compressed radially inwardly with respect to the longitudinal axis 100 of the bag 18b, the sleeve 96 is effective in restraining the compressed blowing wool 98 in its highly compressed state. As the bag 18b is fed through the blowing wool distributing machine 10, the shredder 14 does not have to shred any bag material from the end of the bag 18b.

One advantageous feature of the blowing wool machine of the invention is that the chute 12 need not be any larger in cross-section than the approximate cross-section of the bag 18 of blowing wool. This eliminates the need for a large hopper necessary on conventional blowing wool machines to contain the large volume blowing wool that inevitably results when the blowing wool machine operator opens the bag 18 and releases the blowing wool from its compressed state. With the chute 12 being much smaller than the hoppers of typical blowing wool machines, the entire blowing wool machine 10 is much smaller and lighter in weight than conventional machines. Additionally, with the chute 12 being mounted for a rotation to a retracted position as shown at 12a, the machine can be made even smaller, i.e., shorter in height, it can be more readily transported and stored. These features allow the machine 10 of the invention to be easily transported in many readily available vehicles, such as family vans and sport utility vehicles, whereas conventional blowing wool machines cannot be transported in such vehicles. The easy availability of transport makes the blowing wool machine 10 of the invention amenable to rental by insulation material outlets, such as the big box home improvement stores.

Another advantage of the invention is that by shredding the bag and distributing the pieces of the bag with the blowing wool into the insulation cavity, the need to dispose of the emptied bags in a landfill or recycling operation, as well as the associated labor for handling the waste material, is eliminated.

Although the ripper 20 is advantageously employed as part of the blowing wool machine 10, it is not a requirement that the machine 10 include the ripper. In a broad sense, the machine for distributing blowing wool from a bag 18 of compressed blowing wool must include a mechanism for disposal of a portion of the bag. While this mechanism can be the ripper 20 described in this specification, it can also be any other mechanism for shredding the trailing edge 68 of the bag or otherwise disposing of a portion of the bag. For example, the mechanism can be a feeder, such as a roller, not shown, for feeding an unshredded portion of the bag to a disposal station, such as a collection bin, not shown. Also, the mechanism for disposal of a portion of the bag can be a laser cutter, not shown, for ripping apart a portion of the bag.

In operation the blowing machine 10 incrementally consumes the bag 18 of blowing wool, typically at a rate of about 10 pounds per minute. This incremental consumption results in a lower, more consistent power demand than that experienced with conventional blowing wool machines, thereby enabling the machine 10 to operate on 110 volt power, which is widely available at building construction sites and existing buildings where the blowing wool is being applied in a retrofit application. Also, the steady, incremental consumption of the bag 18 of blowing wool provides an even flow of material into the rotary valve 16, thereby eliminating clumping of the blowing wool and the resultant plugging of the rotary valve 16 or the distribution hose. The steady flow of blowing wool also enables a reduction in the diameter of the distribution hose.

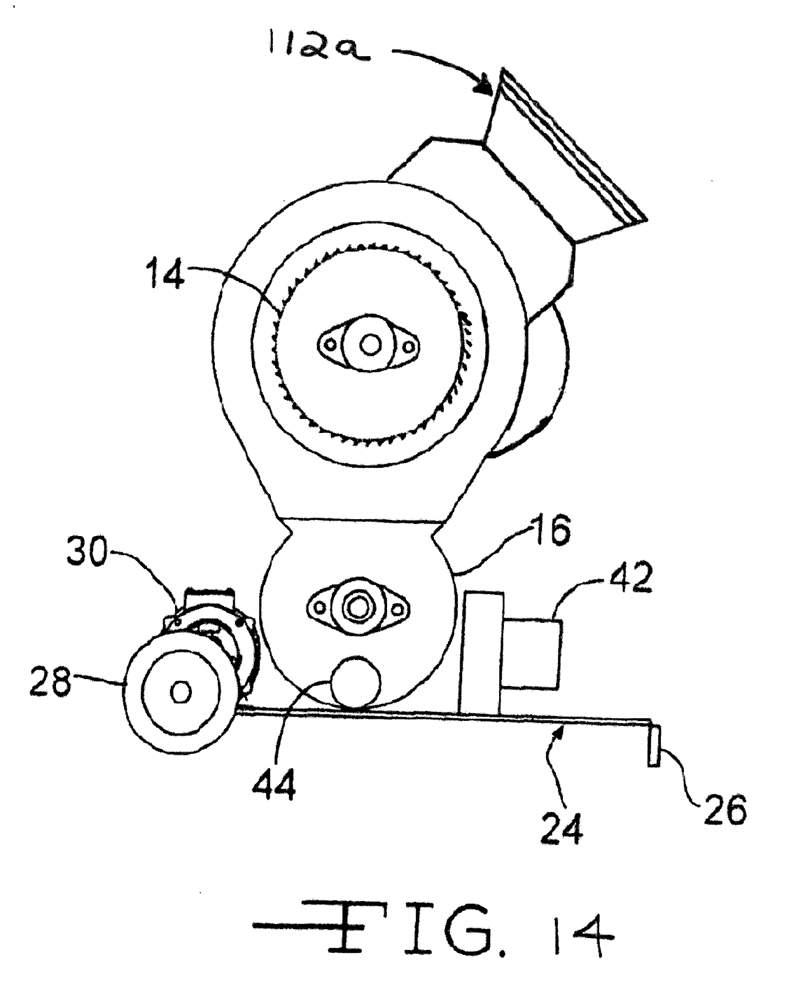

As shown in FIG. 13, in a particular embodiment of the invention, the insulation blowing wool machine 110 is provided with an optional collapsible chute 112 configured to receive the bag 18 of blowing wool. When the invention is used, the collapsible chute 112 extends in a telescoping fashion to a fully extended position. The collapsible chute 112 is then locked in the fully extended position as shown in FIG. 13. Upon completion of the distribution of the picked apart blowing wool, the collapsible chute 112 can be retracted to its collapsed position 112a, as shown in FIG. 14. As shown in FIG. 13, the collapsible chute 112 comprises a plurality of segments 113, which collapse in a retracted position. The segments 113 can be made out of any material suitable to receive the blowing wool and introduce the blowing wool to the separator 14, such as metal, wood, and rigid plastic. The material for the segments 113 can be lightweight for ease of extension and transport. The segments 113 can be configured or shaped so that when the collapsible chute 112 is retracted, the segments 113 nest. The segments 113 are connected by means such as by hinging or linking in any suitable manner to allow the collapsible chute 112 to collapse. The collapsible chute 112 can be provided with a locking mechanism 115, such as a rod as shown in FIG. 13 or any other suitable mechanism for fixing the collapsible chute 112 in the extended position.

Alternatively, the collapsible chute 112 can be a bellows style collapsible chute 212 as shown in FIG. 15 in an extended position. The bellows style chute 212 is then locked in the fully extended position as shown in FIG. 15. Upon completion of the distribution of the picked apart blowing wool, the bellows style collapsible chute 212 can be retracted to its collapsed position 212a, as shown in FIG. 16. As shown in FIG. 15, the bellows style collapsible chute 212 comprises a plurality of folded sections 213, which fold flat in the retracted position 212a. The folded sections 213 can be made out of any material suitable to receive the blowing wool and introduce the blowing wool to the separator 14 such as heavy canvas, plastic, or nylon. The folded segments 213 can be configured or shaped so that when the bellows style collapsible chute 212 is retracted, the folded segments 213 fold in a flat position. The folded segments 213 can be connected by hinging or linking in any manner suitable to allow the bellows style collapsible chute 212 to retract. The bellows style collapsible chute 212 can be provided with a locking mechanism, such as a rod 215 as shown in FIG. 15 or any other suitable mechanism for fixing the bellows style collapsible chute 212 in the extended position.

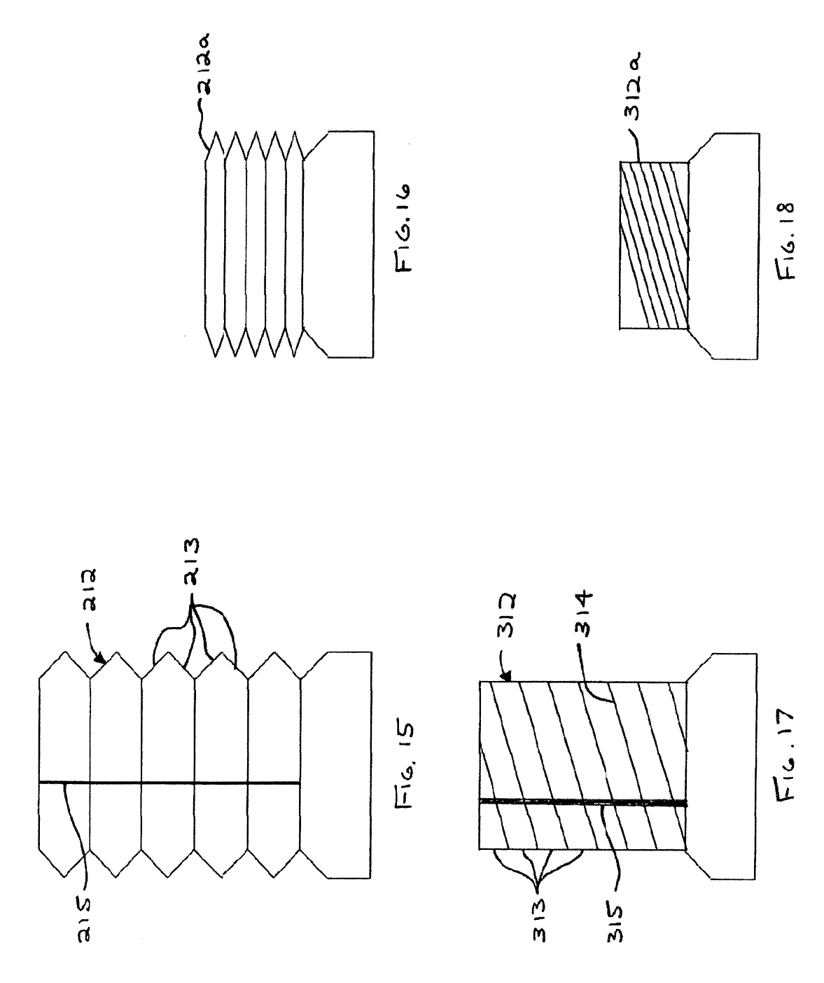

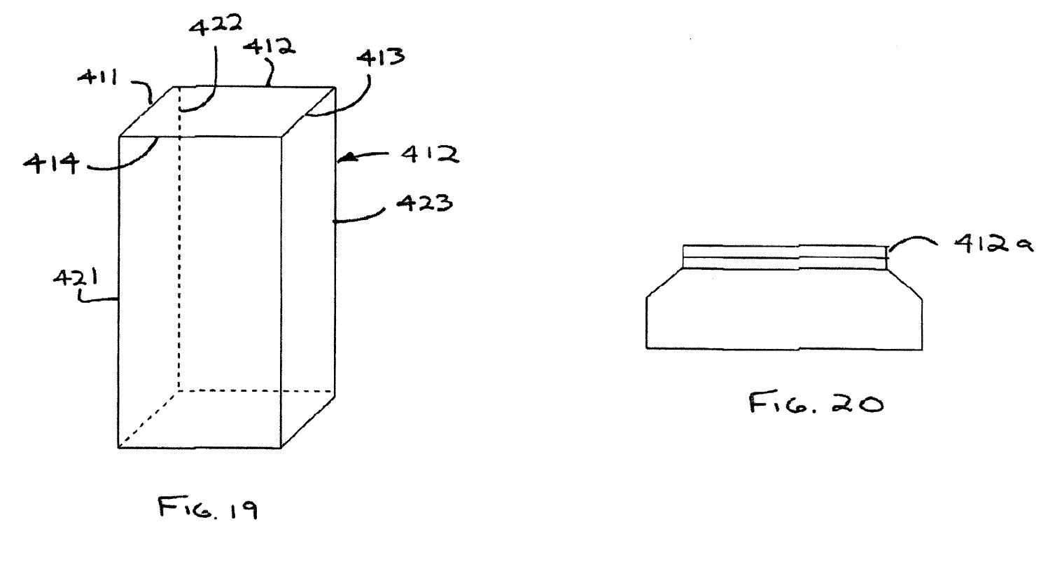

In another embodiment, the collapsible chute can be configured as a spiral style collapsible chute 312 as shown in FIG. 17 in an extended position. The spiral style chute 312 is then locked in the fully extended position as shown in FIG. 17. For ease of storage and transportation, upon completion of the distribution of the picked apart blowing wool, the spiral style collapsible chute 312 can be retracted to its collapsed position 312a, as shown in FIG. 18. As shown in FIG. 17, the spiral style collapsible chute 312 is comprised of a spiral framework 314 and a wrap 313 forming a spiral style collapsible chute 312 suitable to receive the blowing wool and introduce the blowing wool to the separator 14. The spiral framework 314 can be formed from any material, such as metal or plastic suitable to provide a rigid structure for the wrap 313. The wrap 313 can be formed from any material, such as heavy canvas, plastic or nylon, suitable to form a spiral style collapsible chute 312 to receive the blowing wool. The spiral framework 314 and the wrap 313 can be configured or shaped in order that when the spiral shaped chute 312 is retracted, the spiral framework 314 and the wrap 313 collapse in a flat position. The spiral framework 314 and the wrap 313 are connected by hinging or linking in any suitable manner to allow the spiral style collapsible chute 312 to retract. The spiral style collapsible chute 312 can be provided with a locking mechanism, such as a rod 315 as shown in FIG. 17 or other suitable mechanism for fixing the spiral style collapsible chute 314 in the extended position.

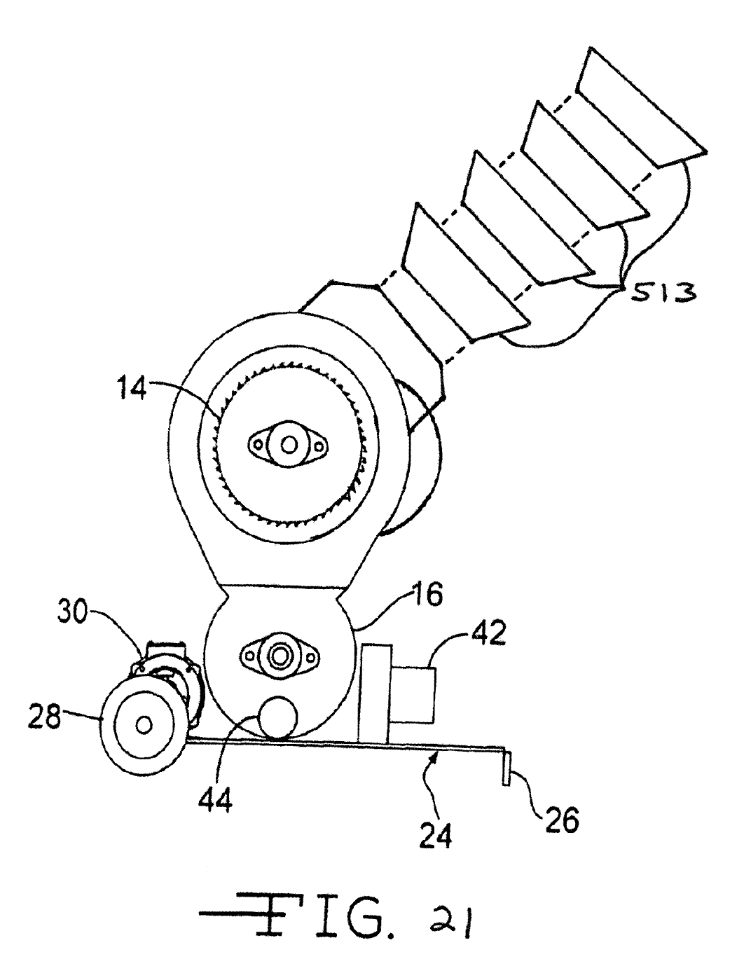

In another embodiment, the collapsible chute 112 can be configured to be a foldable style collapsible chute 412 as shown in FIG. 19 in an extended position. The foldable style chute 412 is then locked in the unfolded position as shown in FIG. 19. The foldable style collapsible chute 412 comprises a plurality of foldable segments 411-414 as shown in FIG. 19 in the unfolded and locked position. The foldable segments 411-414 can be formed from any material, such as metal, wood, plastic or fiberglass, suitable to form the chute to receive the blowing wool and introduce the blowing wool to the separator 14. The material for the foldable segments 411-414 can be lightweight for ease of extension and transport. The foldable segments 411-414 are hinged at the segment edges 421-423. Foldable segments 413 and 414 are connected at segment edge 424 by a connecting mechanism, not shown, such as clips, rods or cotter pins, or any other mechanism suitable to connect and disconnect the foldable segments 413-414. For ease of storage and transportation, upon completion of the distribution of the blowing wool, the foldable style collapsible chute 412 can be folded to its collapsed position 412a, as shown in FIG. 20. The foldable segments 411-414 can be configured or shaped in order that when the foldable style chute 412 is retracted, the foldable segments 411-414 fold in a flat position. The foldable style collapsible chute 412 can be locked to fix the foldable style chute 412 in the unfolded position by a locking mechanism, not shown, such as a cotter pin or any other mechanism suitable to fix the foldable segments 411-414 in the unfolded position.

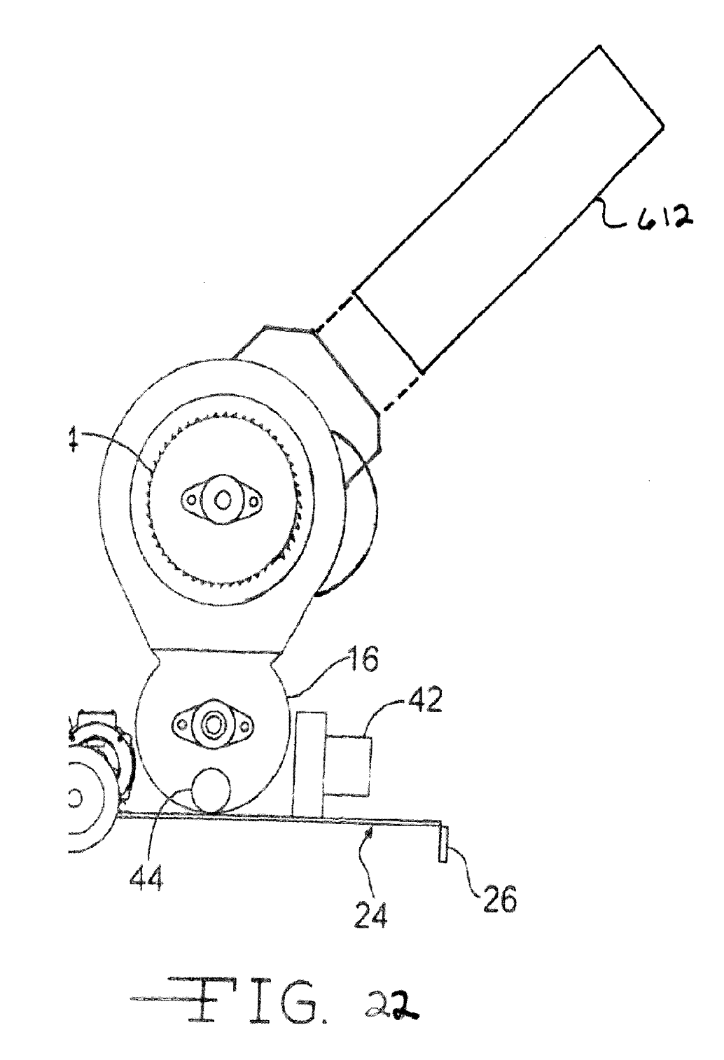

In another embodiment of the invention, the collapsible chute 112 can be readily disassembled and removed for ease of storage and transport. As shown in FIG. 21, the collapsible chute 112 comprises removable segments 513 which are easily disassembled and removed from the invention by the use of fastening mechanisms, not shown, such as a clamps, clips or bolts or any other mechanism suitable to allow easy removal and replacement of the removable segments 513. The removable segments 513 can be removed and replaced without the use of tools or by using simple tools such as a wrench, screwdriver or socket set.

In yet another embodiment of the invention as shown in FIG. 22, a chute 612 is readily removable and replaceable for ease of storage and for transport in a typical sport utility vehicle. The chute 612 comprises a one piece segment and can be any material, such as metal, plastic, fiberglass, suitable to receive the blowing wool and introduce the blowing wool to the separator 14. The chute 612 can be lightweight for ease of removal and transport. As shown in FIG. 22, the collapsible chute 612 is easily removable and replaceable by the use of a fastening mechanism, not shown, such as a clamp, clip or bolts or any other mechanism to allow easy removal and replacement of the chute 612. The chute 612 can be easily removed and replaced without the use of tools or by using simple tools such as a wrench, screwdriver or socket set.

Although the disclosed invention is shown with a shredder 20, any type of separator, such as a clump breaker, beater bar or any other mechanism that picks apart the insulation can be used.

As can be seen by FIGS. 13, 15, 17, 19, and 21, once the chute is reassembled or extended to its operable length, any locking mechanism, such as clips, clamps, cotter pins or bolts, suitable to fix the chute in its operable position can be used.

The principle and mode of operation of this invention have been described in its preferred embodiments. However, it should be noted that this invention may be practiced otherwise than as specifically illustrated and described without departing from its scope.

What is claimed is:

1. A machine for distributing blowing wool from a bag of compressed blowing wool, the machine comprising:
a collapsible chute configured to receive the blowing wool;
a separator mounted at an outlet end of the chute and configured to pick apart the blowing wool; and
a blower for distributing the picked apart blowing wool into an air stream.

2. The machine of claim 1 in which the collapsible chute is comprised of a plurality of segments.

3. The machine of claim 2 in which the segments of the collapsible chute nest.

4. The machine of claim 3 including a locking mechanism to fix the collapsible chute in an extended position.

5. The machine of claim 1 in which the collapsible chute has a bellows configuration.

6. The machine of claim 5 including a locking mechanism to fix the collapsible chute in an extended position.

7. The machine of claim 1 in which the collapsible chute has a spiral configuration.

8. The machine of claim 7 including a locking mechanism to fix the collapsible chute in an extended position.

9. The machine of claim 1 in which the collapsible chute can be configured to be folded.

10. The machine of claim 9 including a locking mechanism to fix the collapsible chute in an unfolded position.

11. The machine of claim 1 in which the separator is a shredder.

12. A machine for distributing blowing wool from a bag of compressed blowing wool, the machine comprising:
a collapsible chute configured to receive the blowing wool, wherein the collapsible chute is comprised of a plurality of segments;
a separator mounted at an outlet end of the chute and configured to pick apart the blowing wool;
a blower for distributing the picked apart blowing wool into an air stream; and
a locking mechanism to fix the collapsible chute in an extended position.

13. The machine of claim 12 in which the segments are connected.

14. A machine for distributing blowing wool from a bag of compressed blowing wool, the machine comprising:
a readily removable and replaceable chute configured to receive the blowing wool,
a separator mounted at an outlet end of the chute and configured to pick apart the blowing wool; and
a blower for distributing the picked apart blowing wool into an air stream.

15. The machine of claim 14 in which the chute is easily removable and replaceable by means of clamps, clips or bolts.

16. The machine of claim 15 in which the chute is comprised of a plurality of removable segments.

17. The machine of claim 15 in which the chute is a one piece segment.
